(19) United States
(12) Patent Application Publication
(10) Pub. No.: US 2005/0049905 A1
(43) Pub. Date: Mar. 3, 2005

(54) Multiple master plans for order simulation and production planning

(75) Inventor: Benny Olesen, Greve (DK)

Correspondence Address: Joseph R. Kelly;Westman, Champlin & Kelly, Suite 1600, 900 Second Avenue South, Minneapolis, MN, 55402-3319, US

(73) Assignee: Microsoft Corporation, Redmond, WA (US)

(21) Appl. No.: 10/648,077

(22) Filed: Aug. 26, 2003

(51) Int. Cl. G06F 17/60

(52) U.S. Cl. 705/8

(57) ABSTRACT

The present invention uses a plurality of master plans to accommodate different functions for different users. A dynamic plan is used for running simulations on proposed orders. A static plan is used for making production planning and inventory ordering decisions.

### BACKGROUND OF THE INVENTION

The present invention deals with master planning and scheduling for manufacturing or production facilities. More specifically, the present invention deals with using a plurality of master plans so that order simulations can be run to provide sales quotes, without affecting the order data used for production planning and inventory control.

In manufacturing or production environments in which a company must maintain an inventory of products or raw materials to fill orders, master planning or scheduling programs are commonly used. In conventional master planning or scheduling programs, (referred to hereafter as a master plan), a single master plan is used in an attempt to satisfy varying requirements of different users.

For example, it is very common in this environment for sales force personnel or order takers to quote prices and delivery dates to potential customers who are shopping for the goods sold by the company. In order to do this, the sales force or order takers have commonly run simulations on the master plan to obtain the pricing and delivery date information. For example, if a potential customer calls a sales person and asks for a delivery date and price of ten units, the sales person typically simulates an order for ten units using the master plan. To do this, the user enters a simulated order for ten units into the master plan. One of the functions of the master plan is to estimate a delivery date for each of the orders entered. Therefore, by exploding certain views of the master plan, the sales person identifies the delivery date and can thus quote that to the potential customer. It has been found almost essential for sales personnel or order takers to be able to quote delivery dates and pricing information on a fairly accurate basis, very quickly.

However, the master plan also serves additional roles. For example, the purchasers that purchase raw materials and inventory for the company also access the master plan in making purchasing decisions. Similarly, production planners access the master plan in order to set production schedules for the various products sold by the company.

Attempting to fulfill the needs of these two groups of people, using a single master plan, has proven problematic. For instance, sales order simulations are actually entered as orders into the master plan. Because the master plan calculates needed inventory purchases and modifies production schedules based on sales orders, the simulated sales orders will momentarily be reflected in the master plan. Therefore, they will be shown to purchasers and schedule planners in the form of new planned purchases of inventory and planned production orders. Of course, since the sales orders are only simulations, they might well be altered or deleted at a later time. This has resulted in a corruption of the data used by master planners and purchasers, in that the simulations introduced temporary fluctuations in planned inventory or raw material order requirements and thus rendered the data used by master planers and purchasers untrustworthy. This required companies using a single master plan to either prohibit sales order simulations from being run on the master plan, or to verify all planned orders prior to making purchasing and schedule planning decisions.

### SUMMARY OF THE INVENTION

The present invention uses a plurality of master plans to accommodate different functions for different users. A dynamic plan is used for running simulations on proposed orders. A static plan is used for making production planning and inventory ordering decisions.

In one embodiment, the static plan is intermittently updated with actual orders. After the static plan is updated, it is copied to the dynamic plan so that simulations can be run on relatively current information. In one specific embodiment, the static plan is updated daily, and is copied to the dynamic plan on a daily basis as well.

### BRIEF DESCRIPTION OF THE DRAWINGS

FIG. 1 is a block diagram of one illustrative environment in which the present invention can be used.

FIG. 2 is a block diagram of a planning system with a plurality of master plans.

FIG. 3 is a flow diagram illustrating one embodiment of the operation of the system shown in FIG. 2.

FIG. 4 is one illustrative embodiment of a user interface for designating a multiple plan system.

### DETAILED DESCRIPTION OF ILLUSTRATIVE EMBODIMENTS

The present invention deals with using multiple master plans for production or manufacturing planning. However, prior to describing the present invention in greater detail, one illustrative environment in which the present invention can be used will be discussed.

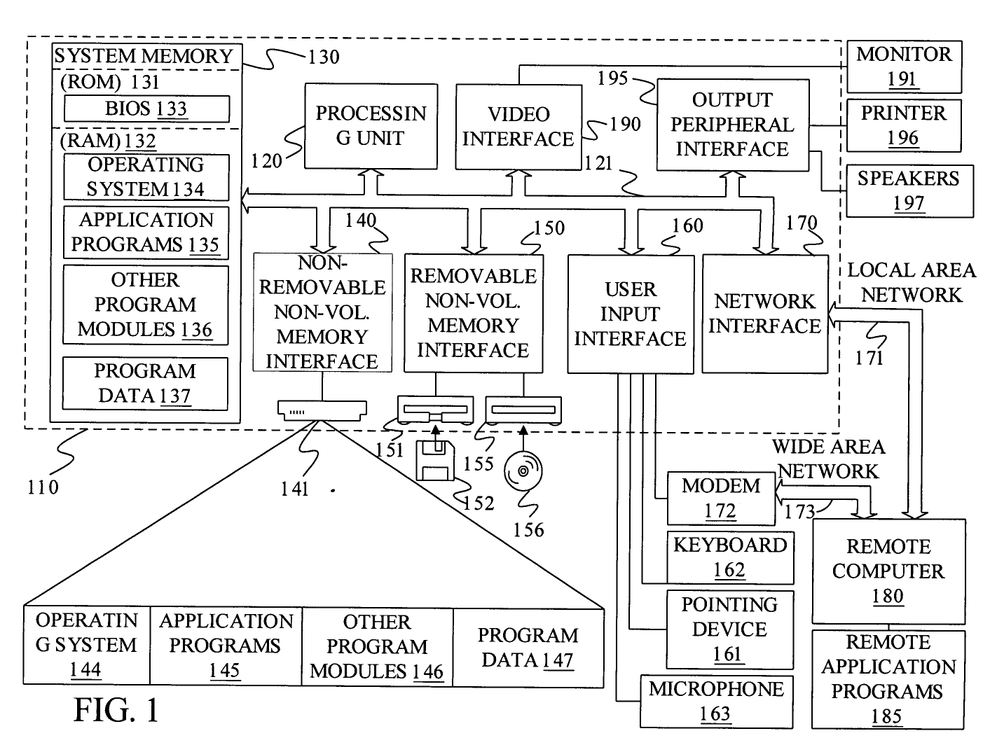

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both locale and remote computer storage media including memory storage devices.

With reference to FIG. 1, an exemplary system for implementing the invention includes general purpose computing device in the form of computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a locale bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way o example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a locale area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

As discussed in the background section, using a single master plan in a manufacturing or production environment can result in problems. Users that are running sales order simulations on the plan in order to quote delivery dates, for example, enter data in the master plan as if it were an actual order so that they may obtain an estimated delivery date. However, production planners and inventory purchasers also use the data entered in the plan in order to set production schedules and purchase inventory. Thus, this can lead to purchasing and production planning decisions being made based on simulated data, instead of actual data.

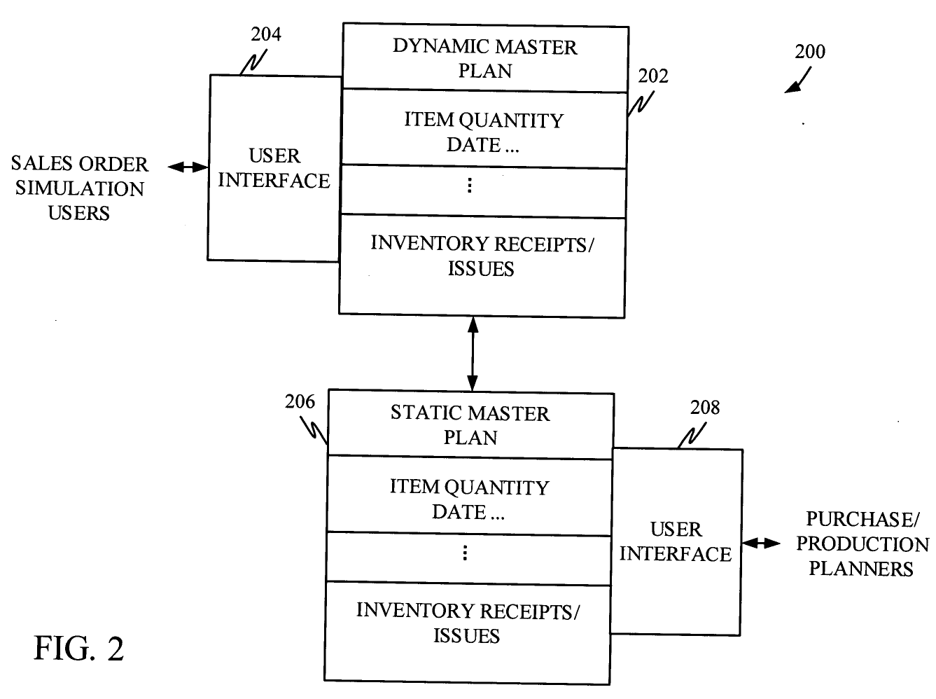

One embodiment of the present invention uses a multiple master plan system, such as system 200 shown in FIG. 2. System 200 includes a dynamic master plan 202 with an associated user interface 204, as well as a static master plan 206 with an associated user interface 208. In one illustrative embodiment, both dynamic master plan 202 and static master plan 206 include a number of records reflecting current actual orders. In addition, dynamic master plan 202 includes records reflecting simulated orders. For instance, the master plans 202 and 206 may include a requirements file with an item identifier identifying an item that has been ordered (or for which a simulation is being run), a quantity identifier identifying the quantity of the item being ordered, a delivery date on which the item will be delivered, etc. The master plans also illustratively include records showing inventory receipts and issues. These records identify items that will be received into inventory and the quantity and dates of receipts of those items, as well as the items that will be issued from inventory in order to fulfill orders.

The master plans also illustratively include a set of rules that are run on the data in the requirements file, and a computing component that applies the rules to the data. The rules are illustratively production planning and inventory control rules which provide an output indicative of an amount of inventory or raw material which must be purchased, by certain dates, based on current orders, and may also output a tentative production schedule which can be used by a production planner in scheduling production of ordered items. Of course, it should be noted that the actual data contained in each of the master plans, and the specific rules applied to that data, as well as the specific output from the master plan can vary widely in form and substance without departing from the present invention.

FIG. 2 also illustrates that dynamic master plan 202 has a user interface that can be accessed by sales order simulation users (those users who wish to run simulations on the master plan data). Static master plan 206 includes user interface 208 that can be accessed by purchasers and production planners in order to make purchasing decisions and schedule production. System 200 allows sales order simulation users to run precise sales order simulations, calculate possible delivery dates to customers, etc., without inadvertently disturbing the existing order data used by the purchasers and production planners, with simulated data.

While any of a wide variety of master plans can be used, to implement plans 202 and 206, one exemplary master plan is that sold under the description Axapta from Microsoft Corporation of Redmond, WA.

Therefore, the static master plan 206 illustratively includes only actual orders, while dynamic master plan 202 contains a copy of all the data from the current static master plan 206 as well as all changes, both actual and simulated, since the last time dynamic master plan 202 was updated from the static master plan 206.

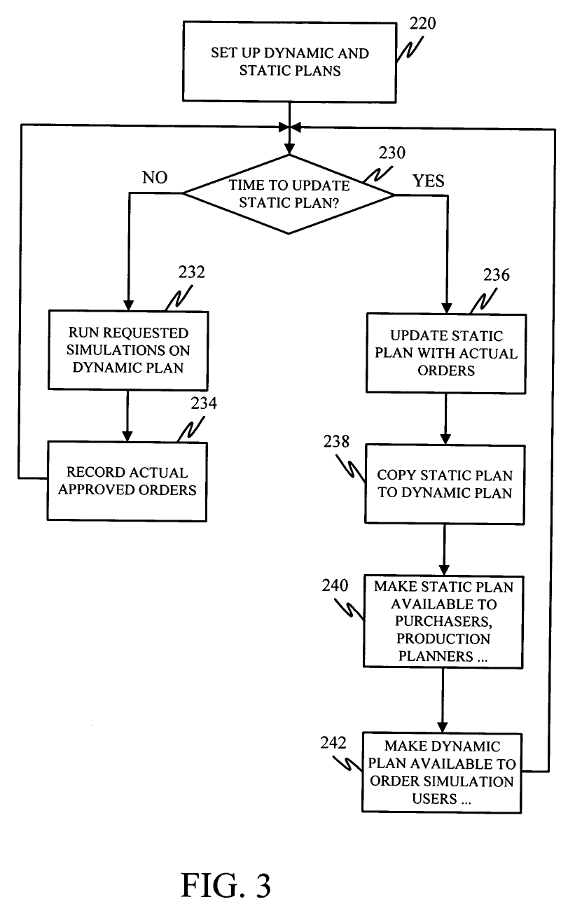

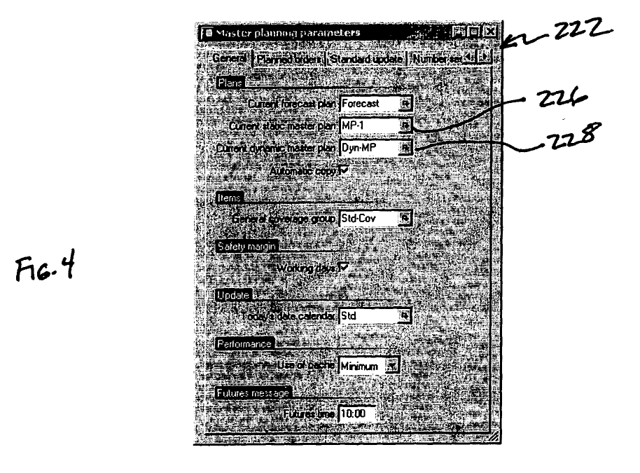

FIG. 3 is a flow diagram illustrating one illustrative embodiment of the operation of system 200 shown in FIG. 2. First, dynamic master plan 202 and static master plan 206 are set up by the user. This is indicated by block 220. FIG. 4 illustrates one embodiment of user interface 204 for setting up the static and dynamic master plans. FIG. 4 shows a dialog box 222 that includes fields 226 and 228 for identifying static master plan 206 and dynamic master plan 202, respectively. A plurality of other parameters can be set using box 222 as well, and they do not form part of the present invention.

Once the static and dynamic master plans have been set up, an update component in one of the master plans determines whether it is time to update the static master plan. This is indicated by block 230 in FIG. 3. Recall that static master plan 206 contains stable data which is used by production planners and inventory purchasers to make purchasing and planning decisions. In one illustrative embodiment, static master plan 206 is updated each night, after the close of business. Therefore, during the day, new orders are simulated on dynamic master plan 202 and actual orders are entered on dynamic master plan 202. Then, at night, the static master plan is updated with only the actual orders that have been confirmed and entered in dynamic master plan 202 during the day.

Therefore, at block 230, it is determined whether the time to update static master plan 206 has arrived. If not, then the update component which is responsible for updating the static master plan 206 does not take any action but instead allows sales order simulation users to run requested simulations on dynamic master plan 202. This is indicated by block 232 in FIG. 3. Because dynamic master plan 202 includes the data representative of the latest received order requests, the delivery dates generated by the simulations will likely be very accurate.

Then, if an order is still recorded in dynamic master plan 202 at the time the static plan is to be updated, it is considered to be an actual approved order. This is indicated by block 234. The order, if not approved, will be removed prior to updating the static master plan 206. This can be done manually through the user interface.

Processing then continues at block 230 where it is determined whether it is time to update static master plan 206 yet. If not, again, simulations can be run and actual orders are confirmed as indicated in blocks 232 and 234.

If, however, at block 230 it is determined that it is time to update static master plan 206, then the actual orders which have been entered into the dynamic master plan 202 during the day, and which have been confirmed as being actual orders, are updated into static master plan 206. This is indicated by block 236 in FIG. 3. Once this data is copied into static master plan 206, a number of optional processing steps can be performed. For example, a master scheduler can be run to update the production planning schedule that is used to schedule production of ordered items. In addition, various inventory reports can be run indicating how much inventory needs to be ordered, and the dates by which it must be ordered, in order to meet the scheduled and confirmed sales orders.

In any case, once static master plan 206 has been updated with actual orders, and the various optional processing steps have been performed, then the update component in static master plan 206 copies the static master plan 206 to dynamic master plan 202. This is indicated by block 238 in FIG. 3. Assuming, for example, that static master plan 206 is updated at night, then it is also copied to dynamic master plan 202 at night. Therefore, dynamic master plan 202 is completely updated with actual orders and the planning and scheduling items calculated based on those orders (identical data to that in static master plan 206) each night. As soon as sales people begin to take orders in the morning, they can run simulations on a completely updated dynamic master plan 202.

The updated static master plan is made available to purchasers and production planners, etc., through user interface 208. Therefore, in the morning, when the purchasers and production planners are setting production schedules and ordering inventory, they have access to the most up-to-date information so that they can generate schedules and place orders accurately. This is indicated by block 240 in FIG. 3. It should also be noted that, because in the illustrated embodiment the static master plan is only updated every night, the purchase and production planners can access the information in static master plan 206 throughout the entire day, because the data is stable for the update period (which may illustratively be one business day).

Similarly, once dynamic master plan 202 has been updated, it is made available to the sales order simulation users so that they can run sales order simulations on the data therein. This is indicated by block 242 in FIG. 3. Because dynamic master plan 202 is dynamically updated, the simulations that will be run are run on data that includes all the actual orders updated at the last update time period, as well as actual orders entered in dynamic master plan 202 since the last update time period, and any other simulated orders (which may or may not turn into actual orders). Thus, the sales order simulation users can provide estimated delivery dates to customers that are highly accurate, and based on real time information.

It can thus be seen that the static master plan 206 is unaffected by possible sales order simulations and changes in the master plan, in general, that occurred throughout the day. The dynamic master plan, by contrast, contains all changes, both real and simulated, and is always kept completely updated with the latest information. In this way, the view of the purchase and production planners is not influenced by a temporary fluctuation in planned order requirements resulting from sales order simulations.

This provides a number of clear advantages. First, the production planners and purchasers are able to make financial and planning decisions based on actual data, instead of actual and simulated data. Similarly, purchasers can make purchasing decisions in a batch format. In other words, if a single master plan is used, even if actual orders are somehow flagged, then a purchaser may be ordering items piecemeal, as the orders come in and are updated to the plan. However, with the present invention, the static master plan 206 is only updated once every update time period (such as once everyday). Therefore, all the actual orders from the previous day are included in the data used by the purchaser to make purchasing decisions. The purchaser will thus likely be able to make larger purchases thereby benefiting from efficiency offered to higher quantity orders.

Also, in prior systems, for a delivery date to be calculated and quoted based on a single master plan, the entire schedule must be recomputed for all of the data in the single master plan every time a simulation is run. This takes a large amount of processing overhead and can be time consuming. By contrast, with the present invention, since the dynamic master plan 202 is updated each time period (such as each day) the scheduling has been computed overnight for all data currently in the plan at the end of the previous day. Thus, the scheduling of a simulated delivery date need only be updated based on the incremental amount of data entered into the plan during the current business day. This allows a user to quote a delivery date much more quickly than in prior systems.

In one exemplary embodiment, the present invention may also allow for probabilistic scheduling. In other words, because two plans are used, one optional embodiment of the invention allows the sales order simulation users to enter orders for simulation in dynamic master plan 202, along with a probability of that simulated order turning into an actual order. For example, the user may get an indication from the customer that if a certain delivery date can be met, it is highly likely that the customer will place the order. Therefore, when entering the simulated order to obtain the delivery date, and assuming the delivery date can be met, the sales person can also enter a probability associated with that simulated order that indicates that it is highly likely the simulated order will turn into an actual order. Then, during later simulations, the scheduling component of dynamic master plan 202 can take into account not only the actual orders in the plan and the simulated orders in the plan, but also the probability that any given simulated order will turn into an actual order. This results in the dynamic master plan being able to quote an even more accurate delivery date. Of course, all this can be done without affecting the data in the static master plan 206.

Similarly, during the update process by which actual orders are updated to static master plan 206, the scheduling procedures are run, and the static master plan 206 is copied to the dynamic master plan 202, the update component in static master plan 206 can optionally take advantage of the probabilities entered as well. For example, the update component may include in its calculations the simulated orders which have a probability that exceeds a threshold level. The threshold level, of course, can be set as desired by the user of the particular system and the precise threshold level does not form part of the present invention. However, by planning production schedules and placing inventory orders based not only on actual orders received, but based on those which are highly likely to be received in the very near future, more efficient production planning and inventory ordering can be accomplished as well.

Although the present invention has been described with reference to particular embodiments, workers skilled in the art will recognize that changes may be made in form and detail without departing from the spirit and scope of the invention.

1. A master scheduling system for use by simulation users and planning users, comprising:
a first master plan including actual sales orders and a first user interface configured to receive a simulated sales order from a simulation user and provide an estimated delivery date corresponding to the simulated sales order, the estimated delivery date being calculated based on the actual sales orders, the simulated sales order and other simulated sales orders currently entered in the first master plan; and
a second master plan including actual sales orders and a second user interface configured to provide production scheduling and inventory ordering data based on the actual sales orders, the second master plan being intermittently updated to obtain an updated second master plan with new actual sales orders and updated production scheduling data and inventory ordering data based on the actual sales orders and new actual sales orders, and the second master plan being intermittently copied to the first master plan so the first and second master plans intermittently contain identical data.

2. The master scheduling system of claim 1 wherein the second master plan is configured to be updated once per day.

3. The master scheduling system of claim 2 wherein the second master plan is configured to be copied into the first master plan once per day, after the second master plan is updated.

4. The master scheduling system of claim 1 wherein the actual sales orders include simulated sales orders that have an assigned probability, of being converted into an actual sales order, above a desired threshold.

5. The master scheduling system of claim 1 wherein the first user interface is configured to enter simulated sales orders only in the first master plan.

6. The master scheduling system of claim 1 wherein the first and second master plans are configured to operate substantially independently of one another accept when the second master plan is updated and when the second master plan is copied to the first master plan.

7. The master scheduling system of claim 1 wherein the second master plan is configured to provide the scheduling data and inventory ordering data without regard to the simulated sales orders.

8. A method of generating estimated delivery dates and of planning production, comprising:
providing first and second master plans, each including actual sales order data indicative of actual sales orders;
entering a simulated sales order in the first master plan;
receiving from the first master plan an estimated delivery date corresponding to the simulated sales order based on the actual sales order data and any other simulated sales orders currently in the first master plan; and
receiving from the second master plan production planning data based on the actual sales order data.

9. The method of claim 8 and further comprising:
intermittently updating the second master plan with new actual sales order data indicative of new actual sales orders, to obtain an updated second master plan.

10. The method of claim 9 and further comprising:
intermittently modifying the first master plan so it contains identical data to the updated second master plan.

11. The method of claim 8 and further comprising:
intermittently modifying the first master plan so it contains identical data to the second master plan.

12. The method of claim 8 wherein receiving from the second master plan production planning data comprises:
receiving the production planning data based on the actual sales order data, without regard to the simulated sales order.

13. The method of claim 8 and further comprising:
inhibiting entry of simulated sales orders in the second master plan.

14. The method of claim 13 wherein inhibiting, comprises:
providing a first user interface for entering the simulated sales order that enters the simulated sales order only in the first master plan.

15. The method of claim 8 and further comprising:
receiving from the second master plan inventory ordering data indicative of inventory to be ordered based on the actual sales order data.

16. The method of claim 9 wherein entering a simulated sales order in the first master plan comprises:
entering a probability indicator indicative of how likely the simulated sales order is to be converted to an actual sales order.

17. The method of claim 16 wherein intermittently updating the second master plan comprises:
updating the second master plan with simulated sales orders that have an associated probability indicator that exceeds a predetermined threshold.

18. A computer readable medium having stored thereon instructions which, when executed by a computer cause the computer to perform a method of generating estimated delivery dates and of planning production, comprising:
identifying first and second master plans, each including actual sales order data indicative of actual sales orders;
receiving a simulated sales order in the first master plan;
outputting from the first master plan an estimated delivery date corresponding to the simulated sales order based on the actual sales order data and any other simulated sales orders currently in the first master plan; and
outputting from the second master plan production planning data based on the actual sales order data.

19. The computer readable medium of claim 18 and further comprising:
intermittently updating the second master plan with new actual sales order data indicative of new actual sales orders, to obtain an updated second master plan.

20. The computer readable medium of claim 19 and further comprising:
intermittently modifying the first master plan so it contains identical data to the updated second master plan.

21. The computer readable medium of claim 18 and further comprising:
intermittently modifying the first master plan so it contains identical data to the second master plan.

22. The computer readable medium of claim 18 and further comprising:
outputting from the second master plan inventory ordering data indicative of inventory to be ordered based on the actual sales order data.

23. The computer readable of claim 19 wherein receiving a simulated sales order in the first master plan comprises:
receiving a probability indicator indicative of how likely the simulated sales order is to be converted to an actual sales order.

24. The computer readable of claim 23 wherein intermittently updating the second master plan comprises:
updating the second master plan with simulated sales orders that have an associated probability indicator that exceeds a predetermined threshold.
